(19) United States
(12) Patent Application Publication
(10) Pub. No.: US 2026/0131786 A1
(43) Pub. Date: May 14, 2026

(54) VEHICULAR CONTROL DEVICE AND VEHICULAR CONTROL METHOD

(71) Applicants: DENSO CORPORATION, Kariya-city (JP); AISIN CORPORATION, Kariya (JP); JTEKT CORPORATION, Kariya-shi (JP); ADVICS CO., LTD., Kariya-city (JP)

(72) Inventor: Kota KAGA, Tokyo (JP)

(21) Appl. No.: 19/442,460

(22) Filed: Jan. 7, 2026

Related U.S. Application Data
(63) Continuation of application No. PCT/JP2024/024077, filed on Jul. 3, 2024.

(30) Foreign Application Priority Data
Jul. 11, 2023 (JP) 2023-114029

(51) Int. Cl. B60W 30/18; B60W 10/04; B60W 10/18; B60W 30/06; B60W 50/00; B60W 50/06

(52) U.S. Cl. CPC B60W 30/181; B60W 10/04; B60W 10/18; B60W 30/06; B60W 30/18109; B60W 50/06; B60W 2050/0042

(57) ABSTRACT

A vehicular control device usable for a vehicle controls a driving force generated from a driving device and a braking force generated from a brake device. Without using a driving response delay time nor a braking response delay time, the vehicular control device determines a reference output schedule of a driving force request and a braking force request for deceleration following a deceleration plan of autonomous traveling control. The vehicular control device provides the driving device with a request for the driving force following the reference output schedule in timing earlier than the reference output schedule by an amount corresponding to the driving response delay time and provides the brake device with a request for the braking force following the reference output schedule in timing earlier than the reference output schedule by an amount corresponding to the braking response delay time.

### CROSS REFERENCE TO RELATED APPLICATIONS

This application is a continuation application of International Patent Application No. PCT/JP2024/024077 filed on Jul. 3, 2024, which designated the U.S. and claims the benefit of priority from Japanese Patent Application No. 2023-114029 filed in Japan on Jul. 11, 2023. The entire disclosures of all of the above applications are incorporated herein by reference.

### TECHNICAL FIELD

The present disclosure relates to a vehicular control device and a vehicular control method.

### BACKGROUND

There is a technology that controls a vehicle so that vehicle speed does not exceed a given speed and the vehicle stops upon reaching a target position designated by an occupant.

### SUMMARY

According to one aspect of the present disclosure, a vehicular control device usable for a vehicle controls a driving force generated from a driving device and a braking force generated from a brake device. Without using a driving response delay time nor a braking response delay time, the vehicular control device determines a reference output schedule of a driving force request and a braking force request for deceleration following a deceleration plan of autonomous traveling control. The vehicular control device provides the driving device with a request for the driving force following the reference output schedule in timing earlier than the reference output schedule by an amount corresponding to the driving response delay time and provides the brake device with a request for the braking force following the reference output schedule in timing earlier than the reference output schedule by an amount corresponding to the braking response delay time.

### BRIEF DESCRIPTION OF THE DRAWINGS

FIG. 1 is a diagram showing an example of a schematic configuration of a vehicular system.

FIG. 2 is a diagram showing an example of a schematic configuration of a driver assist ECU.

FIG. 3 is a diagram showing an example of a schematic configuration of a braking driving control unit.

FIG. 4 is a diagram for description of an example of a manner of determining a fixed value allocated to a low controllability device by an allocation determination unit.

FIG. 5 is a flowchart showing an example of a flow of control in a driver assist ECU during autonomous parking.

FIG. 6 is a flowchart showing an example of a flow of vehicle-stopping process in a braking driving control unit.

FIG. 7 is a diagram for description of a change in braking/driving force in control for stopping the vehicle by the braking driving control unit.

FIG. 8 is a diagram for description of request generation around start of deceleration.

### DETAILED DESCRIPTION

There is a technology that controls a vehicle so that vehicle speed does not exceed a given speed and the vehicle stops upon reaching a target position designated by an occupant.

However, this technology does not take into account a response delay time of an actuator such as a brake device, and therefore may not be able to stop the vehicle at a target vehicle-stop position with high accuracy.

It is an object of the present disclosure to provide a vehicular control device and a vehicular control method that enable a vehicle to stop at a target vehicle-stop position with higher accuracy when autonomous traveling control is executed to stop the vehicle.

According to a first aspect of the present disclosure, a vehicular control device that is usable for a vehicle that executes autonomous traveling control is provided. The vehicular control device includes:
at least one processor that executes a program and/or at least one dedicated circuit, configured to:
in a braking/driving force control process, control a driving force generated from a driving device of the vehicle and a braking force generated from a brake device of the vehicle;
in a performance information acquisition process, acquire performance information on performance of the vehicle, including a driving response delay time and a braking response delay time, wherein the driving response delay time is a response delay time of the driving device in responding to a force request and the braking response delay time is a response delay time of the brake device in responding to a force request; and
in a reference output schedule determination process, without using the driving response delay time nor the braking response delay time, determine, as a reference output schedule, an output schedule of a driving force request and a braking force request for deceleration following a deceleration plan of the autonomous traveling control to stop the vehicle at a target vehicle-stop position, wherein the driving force request is a request to the driving force for the driving force and the braking force request is a request to the brake device for the braking force,
wherein the at least one processor and/or the at least one dedicated circuit is configured to, in the braking/driving force control process, provide the driving device with the request for the driving force following the reference output schedule in timing earlier than the reference output schedule by an amount corresponding to the driving response delay time and provide the brake device with the request for the braking force following the reference output schedule in timing earlier than the reference output schedule by an amount corresponding to the braking response delay time.

According to a second aspect of the present disclosure, a vehicular control method executed by at least one processor and usable for a vehicle that executes autonomous traveling control is provided. The vehicular control method includes:
controlling a driving force generated from a driving device of the vehicle and a braking force generated from a brake device of the vehicle;
acquiring performance information on performance of the vehicle, including a driving response delay time and a braking response delay time, wherein the driving response delay time is a response delay time of the driving device in responding to a force request and the braking response delay time is a response delay time of the brake device in responding to a force request; and
without using the driving response delay time nor the braking response delay time, determining, as a reference output schedule, an output schedule of a driving force request and a braking force request for deceleration following a deceleration plan of the autonomous traveling control to stop the vehicle at a target vehicle-stop position, wherein the driving force request is a request to the driving force for the driving force and the braking force request is a request to the brake device for the braking force,
wherein controlling the driving force and the braking force includes:
providing the driving device with the request for the driving force following the reference output schedule in timing earlier than the reference output schedule by an amount corresponding to the driving response delay time; and
providing the brake device with the request for the braking force following the reference output schedule in timing earlier than the reference output schedule by an amount corresponding to the braking response delay time.

According to the above configuration, when the deceleration is executed to stop the vehicle at the target vehicle-stop position, the request for the braking/driving force is able to be provided in timing earlier by the amount corresponding to the response delay time of the braking/driving device than the request for braking/driving force following the reference output schedule determined without using the driving response delay time nor the braking response delay time. The request to the driving device for the driving force is able to be provided earlier than the reference output schedule by the amount corresponding to the driving response delay time. The request to the brake device for the braking force is able to be provided earlier than the reference output schedule by the amount corresponding to the response delay time of the brake device. Therefore, deviation between timing for output of the braking/driving force scheduled in the reference output schedule and timing of actual output of the braking/driving force is able to be kept small. As a result, when the autonomous traveling control is executed to stop the vehicle, it is possible to stop the vehicle at the target vehicle-stop position with higher accuracy.

Embodiments of the present disclosure will be described with reference to the drawings. Like references are used to refer to like parts to omit duplicated description.

### First Embodiment

### Schematic Configuration of Vehicular System 1

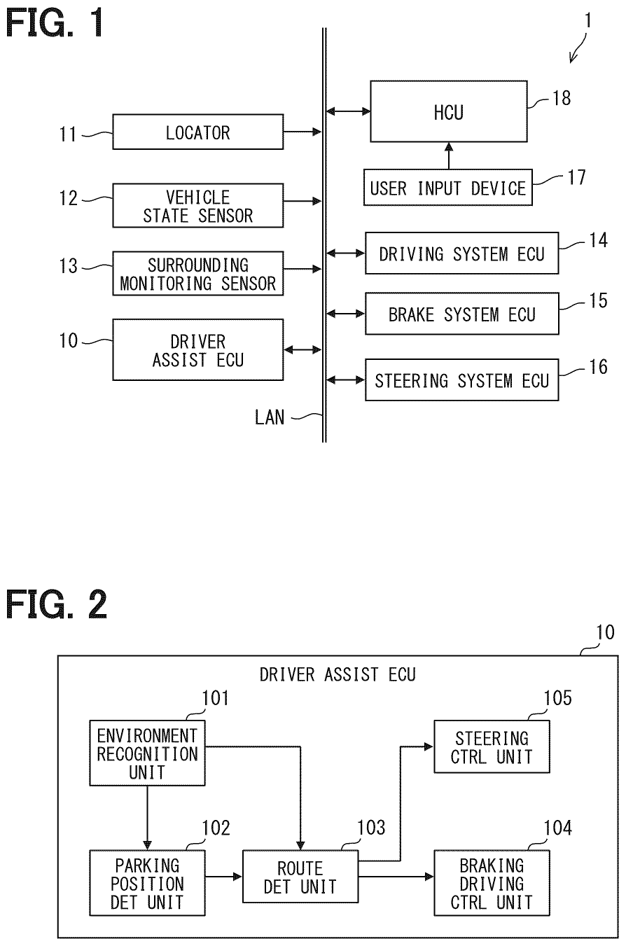

A first embodiment of the present disclosure will be described with reference to the accompanying drawings. The vehicular system 1 shown in FIG. 1 is usable for a vehicle that executes autonomous traveling control. The autonomous traveling control may be also referred to as autonomous driving. As shown in FIG. 1, the vehicular system 1 includes a driver assist ECU 10, a locator 11, a vehicle state sensor 12, a surrounding monitoring sensor 13, a driving system ECU 14, a brake system ECU 15, a steering system ECU 16, a user input device 17, and an HCU (Human Machine Interface Control Unit) 18. For example, the driver assist ECU 10, the locator 11, the vehicle state sensor 12, the surrounding monitoring sensor 13, the driving system ECU 14, the brake system ECU 15, the steering system ECU 16, and the HCU 18 may be connected to an in-vehicle LAN (see FIG. 1 for LAN). Although the vehicle using the vehicular system 1 is not necessarily limited to an automobile, a case using the automobile will be described by way of example.

The system may have multiple levels of driving automation (hereafter referred to as “automation levels”), as defined by SAE, for example. The automation levels are classified into, for example, LV 0 to LV 5 as follows. The LV 0 is a level where a driver performs all driving tasks without system intervention. The driving tasks may be also referred to as dynamic driving tasks. The driving tasks are, for example, steering, acceleration deceleration, and surrounding monitoring. The LV 0 corresponds to so-called manual driving. The LV 1 is a level where a system assists either the steering or the acceleration deceleration. The LV 1 corresponds to so-called driving assistance. The LV 2 is a level where a system assists both the steering and the acceleration deceleration. The LV 2 corresponds to so-called partial driving automation. The LV1 and LV2 are also considered as part of autonomous driving.

For example, in the autonomous driving LV 1 and LV 2, a driver has a monitoring obligation with respect to safety driving (hereinafter simply referred to as a monitoring obligation). That is, this corresponds to autonomous driving with the monitoring obligation. The monitoring obligation includes visual monitoring of surroundings. The autonomous driving at LV1 and 2 may be referred to as autonomous driving in which a second task is not permitted. The second task is an act other than driving permitted for the driver, and is a specific act defined in advance. The second task may be referred to as a secondary activity, other activities, or the like. The second task is required not to prevent the driver from responding to a request to take over a driving operation from an autonomous driving system. Supposed examples of the second task include watching contents such as a video, operating a smartphone, and reading a book.

In the autonomous driving L3, the system is able to perform all driving tasks under specific conditions, and the driver performs the driving operation in emergency situations. In the autonomous driving L3, the driver should be able to respond quickly when the system requests to hand over the driving operation. The driving handover can also be rephrased as transfer of the surrounding monitoring obligation from the vehicular system to the driver. The LV 3 corresponds to so-called conditional driving automation. In the autonomous driving LV4, the system is able to perform all the driving tasks except for under specific situations such as an unsupported road, an extreme environment, and the like. The LV 4 corresponds to so-called advanced driving automation. In the autonomous driving L5, the system is able to perform all the driving tasks under all environments. The LV 5 corresponds to a full driving automation.

For example, the autonomous driving at LV 3 or higher is an autonomous driving in which the driver does not have the monitoring obligation. In other words, the autonomous driving at LV 3 to LV 5 corresponds to autonomous driving without the monitoring obligation. The autonomous driving at LV 3 or higher may be also referred to as autonomous driving in which the second task is permitted. The autonomous traveling control of the present embodiment is such that the system performs at least acceleration and deceleration. The autonomous traveling control of the present embodiment may be autonomous driving with or without the monitoring obligation. The autonomous traveling control of the present embodiment is the autonomous traveling control for autonomous parking. In the following, the autonomous traveling control of the present embodiment will be described on assumption that the system performs all driving tasks during autonomous parking.

The locator 11 includes a GNSS (Global Navigation Satellite System) receiver and an inertial sensor. The GNSS receiver receives positioning signals from positioning satellites. The inertial sensor includes, for example, a gyro sensor and an acceleration sensor. The locator 11 combines the positioning signals received by the GNSS receiver with a measurement result of the inertial sensor to successively detect the position of the host vehicle (hereinafter, a host vehicle position). Locating the host vehicle may also use a travel distance calculated from the signal successively output from a vehicle speed sensor mounted to the vehicle. The host vehicle position is represented by, for example, a center position of the rear axle of the host vehicle and may be expressed as coordinates in the XY coordinate system with the X-axis and Y-axis on the horizontal plane.

The vehicle state sensor 12 is a group of sensors for detecting various states of the host vehicle. The vehicle state sensor 12 includes a vehicle speed sensor, a steering angle sensor, etc. The vehicle speed sensor detects the speed of the host vehicle. The steering angle sensor detects a steering angle, such as the steering angle or turning angle of the host vehicle. The vehicle state sensor 12 outputs detected sensing information to the in-vehicle LAN. The sensing information detected by the vehicle state sensor 12 may be output to the in-vehicle LAN via an ECU mounted to the host vehicle.

The surrounding monitoring sensor 13 monitors a surrounding environment of the host vehicle. For example, the surrounding monitoring sensor 13 detects an obstacle around the host vehicle, such as a pedestrian, a movable object such as another vehicle, and a stationary object such as a fallen object on the road. Additionally, a road marking such as a lane marking outside host vehicle is detected. The surrounding monitoring sensor 13 is, for example, a surrounding monitoring camera that captures an image of a predetermined range outside the host vehicle, or a probe wave sensor that transmits probe waves to a predetermined range outside the vehicle. Examples of the probe wave sensor include a millimeter wave radar, a sonar, a LIDAR (Light Detection and Ranging/Laser Imaging Detection and Ranging). For example, the predetermined range may be a range at least partially covering the front area, the rear area, the left area, or the right area of the host vehicle. The surrounding monitoring camera outputs the successively captured image to the driver assist ECU 10 as the sensing information. As the sensing information output to the driver assist ECU 10, the probe wave sensor successively outputs a scanning result based on the received signal obtained when the probe wave sensor receives a reflected wave reflected by an obstacle.

The driving system ECU 14 and the brake system ECU 15 are electronic control units that execute acceleration deceleration control. The driving system ECU 14 controls the driving device of the host vehicle. When the vehicle uses an internal combustion engine as a traveling power source, the driving system ECU 14 may be, for example, an engine ECU. When the vehicle uses a motor as the traveling power source, the driving system ECU 14 may be, for example, a power unit control ECU. The traveling power source corresponds to the driving device. The brake system ECU 15 controls the brake device of the vehicle. The brake system ECU 15 may be, for example, a brake ECU. The driving device and the brake device are collectively referred to as a driving braking device. The steering system ECU 16 is an electronic control unit that executes steering control. The steering system ECU 16 controls a steering device of the host vehicle. The steering system ECU 16 may be, for example, a steering ECU. An actuator for steering corresponds to a steering device.

The user input device 17 receives an input from an occupant of the vehicle. The user input device 17 may be an operation device that receives an operation input from an occupant. The operation device may be a mechanical switch, or a touch switch integrated with a display device. The user input device 17 is not limited to the operation device that receives the operation input, as long as it is a device that receives an input from an occupant. For example, the user input device 17 may be a speech input device that receives a command input from the occupant by way of speech. The user input device 17 includes an auto-parking activation switch (“AP switch”). The AP switch is a switch for activating an autonomous parking function of the driver assist ECU 10.

The HCU 18 includes, as its main component, a computer including a processor, a volatile memory, a nonvolatile memory, I/O, and a bus connecting these. The HCU 18 executes various processes related to interaction between an occupant and a system of the host vehicle by executing a control program stored in the nonvolatile memory. The HCU 18 acquires information on the input received from the occupant at the user input device 17.

The driver assist ECU 10 includes, as its main component, a computer including, for example, a processor, a volatile memory, a nonvolatile memory, I/O, and a bus connecting these. The driver assist ECU 10 executes processes related to the autonomous parking by executing a control program stored in the nonvolatile memory. The configuration of the driver assist ECU 10 will be described in detail below.

### Schematic Configuration of Driver Assist ECU 10

The schematic configuration of the driver assist ECU 10 will be described using FIG. 2. As shown in FIG. 2, the driver assist ECU 10 includes an environment recognition unit 101, a parking position determination unit 102, a route determination unit 103, a braking driving control unit 104, and a steering control unit 105 as functional blocks. Part or all of the functions performed by the driver assist ECU 10 may be configured by a hardware component such as one or more ICs. Alternatively, part or all of the functional blocks of the driver assist ECU 10 may be provided by a processor executing software in combination with a hardware component.

The environment recognition unit 101 recognizes a traveling environment of the host vehicle from the sensing information acquired from the surrounding monitoring sensor 13. By using the sensing information from the surrounding monitoring sensor 13, the environment recognition unit 101 recognizes the position, shape, and movement state of an object around the host vehicle and generates a virtual space reproducing the actual traveling environment. The environment recognition unit 101 may also recognize the position of the lane marking around the host vehicle. The environment recognition unit 101 detects a parking space from the recognized traveling environment. The parking space is an open space where the host vehicle is able to be parked. Whether or not the space is open may be determined by the environment recognition unit 101 based on the size of the host vehicle. As an example, the environment recognition unit 101 may detect that an open space between obstacles or adjacent to an obstacle is the parking space. The environment recognition unit 101 may also detect an open space between car park line markings as the parking space.

The parking position determination unit 102 determines a target parking position for parking the vehicle in the parking space detected by the environment recognition unit 101. The target parking position may be determined so that the host vehicle fits into the parking space. This target parking position corresponds to a target vehicle-stop position. The parking position determination unit 102 may determine the parking space according to the input received at the user input device 17. In other words, the parking space selected by the occupant from among candidate parking spaces may be determined as the parking space.

The route determination unit 103 determines a target path (also called a route) that the host vehicle is to follow to the target parking position determined by the parking position determination unit 102 while avoiding contact with obstacles. This route is referred to hereinafter as a scheduled route. The route determination unit 103 may successively re-determine the target path to adapt to changing situations.

The braking driving control unit 104 determines a target vehicle speed and a target acceleration for moving the host vehicle following the scheduled route determined by the route determination unit 103. For example, the target vehicle speed during traveling of the vehicle may be a fixed speed. The target vehicle speed and the target acceleration for stopping the vehicle at the target parking position may be determined, for example, such that the target vehicle speed and the target acceleration decrease according to a sensory index. The sensory index represents a comfortable speed change for the occupant and is preset via experiments, simulations, etc. For example, the braking driving control unit 104 determines a plan for a change in the target vehicle speed and the target acceleration from the time to start the deceleration under the autonomous traveling control for stopping the vehicle at the target vehicle-stop position. Hereafter, this plan is referred to as a deceleration plan. The time to start the deceleration under the autonomous traveling control for stopping the vehicle at the target vehicle-stop position is hereinafter referred to as a vehicle-stop deceleration start timing. In order to stop the vehicle at the target parking position by changing the target vehicle speed and the target acceleration according to the sensory index, the vehicle-stop deceleration start timing is determined so as to depend on the vehicle speed. The braking driving control unit 104 may determine the deceleration plan according to this vehicle-stop deceleration start timing.

The braking driving control unit 104 determines a braking/driving force for attaining the determined target vehicle speed and target acceleration. The braking/driving force may be referred to as brake driving power. The braking/driving force is a collective term for such forces as the braking force and the driving force. The braking force may be referred to as braking power. The driving force may be referred to as driving power. The braking/driving force refers to at least one of the braking force or the driving force. The braking force and the driving force may be expressed, for example, in units of N (newton). The braking force is a negative value, and the driving force is a positive value. The braking driving control unit 104 commands the driving system ECU 14 and the brake system ECU 15 to generate the determined braking/driving force. Because of this, the driving force generated from the traveling drive source and the braking force generated from the brake device are controlled. The braking driving control unit 104 determines and controls the braking/driving force for starting the host vehicle from a stopped state. The braking driving control unit 104 determines and controls the braking/driving force during traveling after starting the vehicle. The braking driving control unit 104 determines and controls the braking/driving force for stopping the vehicle. A process by the braking driving control unit 104 for stopping the vehicle at the target parking position will be described in detail later. The process for stopping the vehicle at the target parking position is referred to hereinafter as a vehicle-stopping process. It is assumed that, before shifting to the vehicle-stopping process, the vehicle travels, for example, at a constant speed under the autonomous travelling control.

The steering control unit 105 determines a target steering angle for the host vehicle to move along the scheduled route determined by the route determination unit 103. For example, the target steering angle at a point on the scheduled route located ahead of the host vehicle position by a response distance. The response distance in this case may be a distance that the host vehicle is estimated to travel in the response delay time of the steering control. The target steering angle is uniquely determined from a curvature of the scheduled route at a target point. A relationship between the curvature of the path and the target steering angle derived in advance by testing or other means may be used. The steering control unit 105 commands the steering system ECU 16 to attain the determined target steering angle. Because of this, the actuator for steering is controlled and the steering angle of the host vehicle is autonomously changed.

### Schematic Configuration of the Braking Driving Control Unit 104

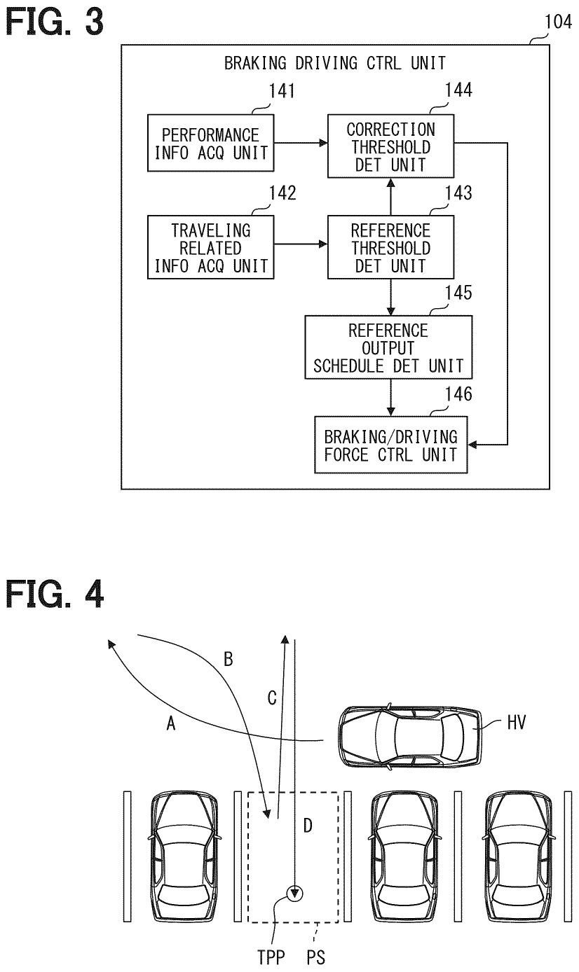

Using FIG. 3, a schematic configuration of the braking driving control unit 104 with respect to the vehicle-stopping process will be described. With respect to the vehicle-stopping process, as shown in FIG. 3, the braking driving control unit 104 includes a performance information acquisition unit 141, a traveling related information acquisition unit 142, a reference threshold determination unit 143, a correction threshold determination unit 144, a reference output schedule determination unit 145, and a braking/driving force control unit 146. The braking driving control unit 104 corresponds to a vehicular control device. Execution of processing of each functional block of the braking driving control unit 104 by a computer corresponds to execution of a vehicular control method.

The performance information acquisition unit 141 acquires performance information on performance of the host vehicle. The performance information may be information on performance of an actuator such as the brake device and the driving device of the host vehicle. The brake device and the driving device are collectively referred to as the actuator. The performance information acquisition unit 141 may acquire the performance information prestored in the non-volatile memory of the driver assist ECU 10. In an alternative configuration, the performance information may be stored in a non-volatile memory other than that of the driver assist ECU 10. The performance information includes a driving response delay time and a braking response delay time. The process in the performance information acquisition unit 141 corresponds to a performance information acquisition process. The driving response delay time is a response delay time of the drive unit in responding to a force request (i.e., a request for a force). This force may be the driving force. The braking response delay time is a response delay time of the brake device in responding to a force request (i.e., a request for a force). This force may bet the braking force. The performance information may further include information other than that described above.

The traveling related information acquisition unit 142 acquires traveling related information on traveling of the host vehicle. The traveling related information includes the current speed of the host vehicle, the host vehicle position, the scheduled route, and the target parking position. The vehicle speed may be acquired from the vehicle speed sensor of the vehicle state sensor 12. The host vehicle position may be acquired from the locator 11. The scheduled route determined by the route determination unit 103 may be acquired. The target parking position determined by the parking position determination unit 102 may be acquired.

The reference threshold determination unit 143 determines a reference threshold serving as a condition for transition to deceleration control for stopping the vehicle at the target parking position. The reference threshold is a value of a remaining parking distance at which the vehicle is to start the deceleration. The remaining parking distance is a remaining distance from the vehicle to the target parking position. The reference threshold is determined without using the driving response delay time nor the braking response delay time. In other words, the reference threshold is a theoretical value without taking into account the driving response delay time nor the braking response delay time. The reference threshold determination unit 143 determines the reference threshold according to the remaining parking distance and the current vehicle speed. The reference threshold determination unit 143 may specify the remaining parking distance, based on the host vehicle position, the scheduled route, and the target parking position acquired by the traveling related information acquisition unit 142. As the current vehicle speed, the reference threshold determination unit 143 may specify the current vehicle speed acquired by the traveling related information acquisition unit 142. The reference threshold determination unit 143 may determine the reference threshold in, for example, the below-described way. First, the vehicle-stop deceleration start timing depending on the current vehicle speed is determined from the current vehicle speed. The remaining parking distance at the position corresponding to this vehicle-stop deceleration start timing is determined as the reference threshold.

The correction threshold determination unit 144 determines a driving-side threshold by correcting the reference threshold for the driving device such that the driving-side threshold is longer than the reference threshold by an amount corresponding to the driving response delay time. In the above, the driving response delay time acquired by the performance information acquisition unit 141 is used. The reference threshold determined by the reference threshold determination unit 143 is used. The correction threshold determination unit 144 may determine the driving-side threshold by correcting the reference threshold such that the driving-side threshold is longer than the reference threshold by the distance traveled in the driving response delay time at the current vehicle speed. The correction threshold determination unit 144 determines a braking-side threshold by correcting the reference threshold for the brake device such that the braking-side threshold is longer than the reference threshold by an amount corresponding to the braking response delay time. In the above, the braking response delay time acquired by the performance information acquisition unit 141 is used. The correction threshold determination unit 144 may determine the braking-side threshold by correcting the reference threshold such that the braking-side threshold is longer than the reference threshold by the distance traveled in the braking response delay time at the current vehicle speed.

The reference output schedule determination unit 145 determines an output schedule of a request braking/driving force for attaining the deceleration following the deceleration plan, without using the driving response delay time nor the braking response delay time. Specifically, the reference output schedule determination unit 145 determines the output schedule of the request braking/driving force on assumption that the driving response delay time and the braking response delay time are zero. The deceleration plan is, as described above, a plan of vehicle behavior in the autonomous traveling control for stopping the vehicle at the target parking position, wherein the vehicle behavior includes the change in the target vehicle speed and the target acceleration. The request braking/driving force is a collective term for a request to the driving device for the driving force and a request to the brake device for the braking force. The request braking/driving force may be also referred to as the request for the braking/driving force. The process in the reference output schedule determination unit 145 corresponds to a reference output schedule determination process. If the deceleration plan is changed, the reference output schedule determination unit 145 may accordingly change the output schedule of the request braking/driving force. The reference output schedule determination unit 145 may successively execute feedback correction to the reference output schedule to reduce a difference between the actually generated braking/driving force and the braking/driving force requested by the braking/driving force control unit 146 described below.

The braking/driving force control unit 146 controls the driving force generated from the driving device and the braking force generated from the brake device of the host vehicle. The braking/driving force control unit 146 controls the driving force generated from the driving device by issuing the command to the driving system ECU 14. The braking/driving force control unit 146 controls the braking force generated from the brake device by issuing the command to the brake system ECU 15. The braking/driving force control unit 146 provides the driving device with the request for the driving force following the reference output schedule in timing earlier than the reference output schedule by an amount corresponding to the driving response delay time. Specifically, to do so, the braking/driving force control unit 146 shifts phase of the change in the request for the driving force in the reference output schedule by an amount corresponding to the driving response delay time. The braking/driving force control unit 146 provides the brake device with the request for the braking force following the reference output schedule in timing earlier than the reference output schedule by an amount corresponding to the braking response delay time. Specifically, to do so, the braking/driving force control unit 146 shifts phase of the change in the request for the braking force in the reference output schedule by an amount corresponding to the braking response delay time. In the above, the reference output schedule determined by the reference output schedule determination unit 145 is used. The driving response delay time acquired by the performance information acquisition unit 141 is used. The braking response delay time acquired by the performance information acquisition unit 141 is used. The timing adjusted earlier in the above way may be time-based timing or position-based timing. When the timing adjusted earlier is the time-based timing, a time point when a certain output request is issued in the reference output schedule is shifted to an earlier time point by the response delay time. The response delay time is a collective term for the driving response delay time and the braking response delay time. When the timing adjusted earlier is the position-based timing, a position where a certain output request is issued in the reference output schedule is shifted to an early-reached position by a distance traveled in the response delay time at the current vehicle speed. The process in the braking/driving force control unit 146 corresponds to a braking/driving force control process.

According to the above configuration, the request to the driving device for the driving force is able to be provided in the timing earlier than the reference output schedule by the amount corresponding to the driving response delay time. The request to the brake device for the braking force is able to be provided in the timing earlier than the reference output schedule by the amount corresponding to the braking response delay time. Therefore, deviation between the timing for output of the braking/driving force scheduled in the standard output schedule and the timing of actual output of the braking/driving force is able to be kept small. As a result, when the autonomous traveling control is executed to stop the vehicle, it is possible to stop the vehicle at the target vehicle-stop position with higher accuracy.

It may be preferable that from the start of the deceleration in the deceleration plan, the braking/driving force control unit 146 provides the driving device with the request for the driving force in the timing earlier than the reference output schedule. It may be preferable that from the start of the deceleration in the deceleration plan, the braking/driving force control unit 146 provides the brake device with the request for the braking force in the timing earlier than the reference output schedule. Because of this, from the start of the deceleration for parking, the deviation between timing of output of the braking/driving force scheduled in the reference output schedule and timing of actual output of the braking/driving force is able to be kept small. Thus, with higher accuracy, it is possible to stop the vehicle at the target parking position with the deceleration conforming to the deceleration plan less uncomfortable for the occupant. Therefore, it is possible to highly-accurately stop the vehicle at the target vehicle-stop position while suppressing discomfort feeling of the occupant.

In order to, from the start of the deceleration in the deceleration plan, provide the request for the braking/driving force in the timing earlier than the reference output schedule, the braking/driving force control unit 146 may execute the following. When the remaining parking distance reaches the driving-side threshold, the braking/driving force control unit 146 may start providing the request for the driving force scheduled in the standard output schedule as the driving force at the time to start the deceleration. In the above, the driving-side threshold determined by the correction threshold determination unit 144 is used. When the remaining parking distance reaches the braking-side threshold, the braking/driving force control unit 146 may start providing the request for the braking force scheduled in the standard output schedule as the driving force at the time to start the deceleration. In the above, the braking-side threshold determined by the correction threshold determination unit 144 is used. According to the above configuration, from the start of deceleration in the deceleration plan, it is possible to more easily provide the driving unit with the request for the driving force in the timing earlier than the reference output schedule.

The braking/driving force control unit 146 may successively provide the driving device with the request for the driving force in, for example, the below-described way. To provide the driving device with the request, the braking/driving force control unit 146 may execute a merge process on a request value of the time-shifted driving force at a time point and a request value of the driving force at this time point in the reference output schedule, wherein the time-shifted driving force is the driving force in the reference output schedule time-shifted in an early direction. In the following, the request value of the driving force in the reference output schedule (i.e., following the reference output schedule) is referred to as a reference driving request value. The request value of the time-shifted driving force is referred to as a phase compensation driving request value. In the merge process, a difference from the phase compensation driving request value is added to the reference driving request value in the same timing. The braking/driving force control unit 146 may successively provide the brake device with the request for the braking force in, for example, the below-described way. To the provide the brake device with the request, the braking/driving force control unit 146 may execute a merge process on a request value of the time-shifted braking force at a time point and a request value of the driving force at this time point in the reference output schedule. In the following, the request value of the braking force in the reference output schedule (i.e., following the reference output schedule) is referred to as a reference driving request value. The request value of the time-shifted braking force is referred to as a phase compensation braking request value. In the merge process, a difference from the phase compensation braking request value is added to the reference braking request value in the same timing.

### Flow for Autonomous Parking

Now, an example of an overall flow for the autonomous parking will be described using FIG. 4. In FIG. 4, HV refers to the host vehicle. PS in FIG. 4 refers to the parking space. TPP in FIG. 4 refers to the target parking position. A A, B, C, and D in FIG. 4 refers to step of the autonomous parking.

As shown in FIG. 4, when the host vehicle is in a stopped state in the vicinity of a parking unit for example, the autonomous parking starts. For example, the stopped state of the host vehicle may be due to a manual operation by the occupant of the host vehicle. Specifically, the stopped state may be due to a braking operation by the occupant of the host vehicle. The stopped state may be due to the autonomous driving by the system. Upon the autonomous parking starting, the host vehicle HV is moved forward for vehicle position orientation adjustment (see FIG. 4 for A). In the vehicle position orientation adjustment, the host vehicle HV is moved forward while turning to attain a vehicle position orientation that allows the vehicle to move into the parking space PS in reverse motion. Then, the host vehicle HV is move into the parking space PS in reverse motion (see FIG. 4 for B). Then, the vehicle is moved forward to make a turnaround for aligning the host vehicle position with the target parking position TPP (see FIG. 4 for C). Finally, the host vehicle HV is moved in reverse to align the host vehicle position with the target parking position TPP (see FIG. 4 for D).

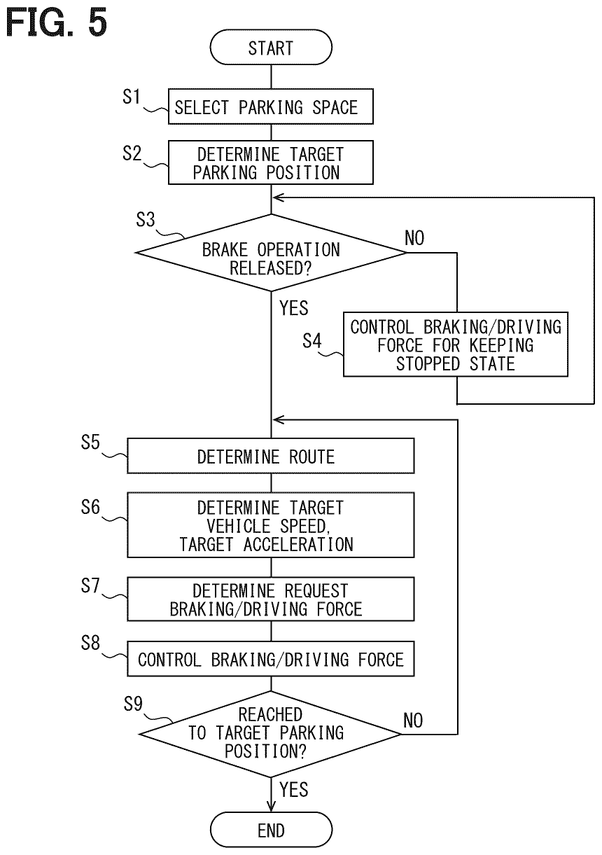

Using the flowchart in FIG. 5, an example flow of the control by the driver assist ECU 10 during the autonomous parking will be described. FIG. 5 illustrates an example case where a brake operation by the occupant is required to maintain the stopped state before starting. The flowchart in FIG. 5 starts upon, for example, turn ON of the AP switch when the host vehicle is in the stopped state in the vicinity of a parking section. For descriptive purpose, description of steering control is omitted, and the braking/driving force control will be described.

First, in step S1, the parking position determination unit 102 accepts selection of a parking space in which the host vehicle is to be parked. The parking position determination unit 102 may determine the parking space according to the input received from the occupant at the user input device 17. As an example, the system may be configured to allow the occupant to select a parking space from the candidate parking spaces displayed on the display unit of the host vehicle. In step S2, the parking position determination unit 102 determines the parking space selected in S1 as being the target parking position.

In step S3, if the brake operation by the occupant is released (YES in S3), the process proceeds to step S5. If the brake operation by the occupant is not released (NO in S3), the system proceeds to step S4. The driver assist ECU 10 may determine whether the brake operation is released or not, based on the sensing information of the brake sensor. For example, a brake operation release timing may be treated as timing to start control of the host vehicle starting.

In step S4, the braking driving control unit 104 executes the braking/driving force control for maintaining the vehicle stopped state. Then, the process returns to step S3. In the braking/driving force control for maintaining the vehicle stopped state, when the brake operation by the occupant alone is insufficient to maintaining the vehicle stopped state, the braking driving control unit 104 generates the braking/driving force corresponding to the insufficiency. In other words, when the braking force requested by the brake operation of the occupant alone is insufficient to maintaining the vehicle stopped state, the braking/driving force is generated for compensating the insufficiency.

In step S5, the route determination unit 103 determines the route for traveling to the target parking position determined in S2 under the autonomous parking. The route determination unit 103 may successively re-determine the target path to adapt to changing situations. In step S6, the braking driving control unit 104 determines the target vehicle speed and the target acceleration for moving the host vehicle along the route determined in S5. In step S7, the braking driving control unit 104 determines the request braking/driving force for attaining the target vehicle speed and the target acceleration determined in S6.

In step S8, the braking driving control unit 104 executes control so that the request braking/driving force determined in S7 is generated. In step S9, if the host vehicle has reached the target parking position (YES in S9), the flow ends. If the host vehicle has not reached the target parking position (NO in S9), the process returns to S5 and repeats.

### Vehicle-Stopping Process in Braking Driving Control Unit 104

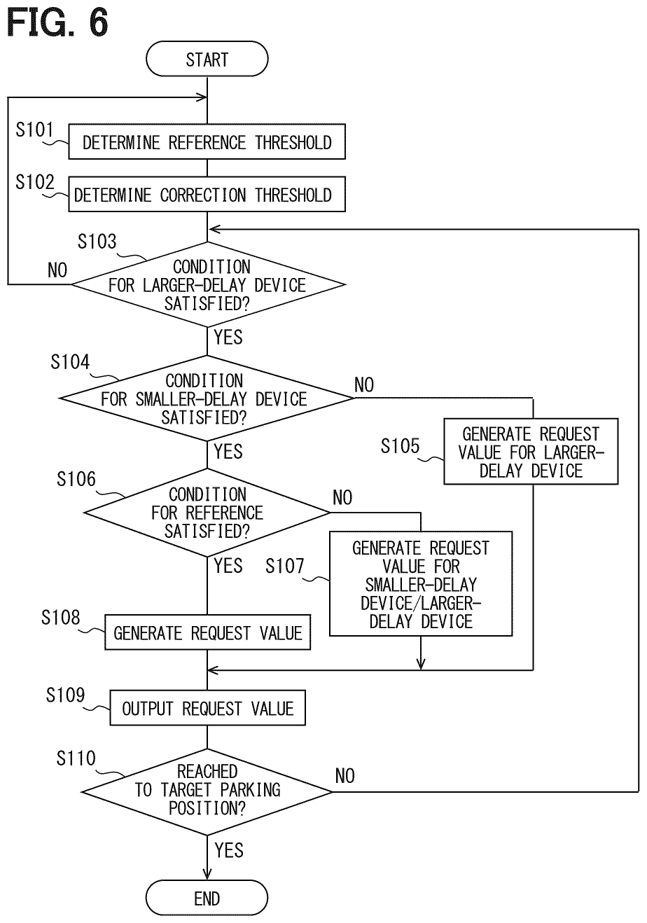

Using the flowchart in FIG. 6, an example flow of the vehicle-stopping process in the braking driving control unit 104 will be described. FIG. 6 illustrates an example case where the host vehicle executes the autonomous parking. When the vehicle executing the autonomous parking reaches a specified distance from the target parking position, the flowchart in FIG. 6 may start. The specified distance may be longer than the remaining parking distance at which the deceleration in the deceleration plan starts.

First, in step S101, the reference threshold determination unit 143 determines the reference threshold being the condition for transition to the deceleration control for stopping the vehicle at the target parking position. The remaining parking distance reaching the criteria threshold is the below-described satisfaction of the reference condition (also referred to as the condition for reference).

In step S102, the correction threshold determination unit 144 determines the driving-side threshold and the braking-side threshold. In the following, the driving-side threshold and the braking-side threshold are collectively referred to as a correction threshold. The driving-side threshold is a threshold obtained by correcting the reference threshold for the driving device such that the driving-side threshold is longer than the reference threshold by the amount corresponding to the driving response delay time, as described above. The braking-side threshold is a threshold obtained by correcting the reference threshold for the brake device such that the braking-side threshold is longer than the reference threshold by the amount corresponding to the braking response delay time, as described above. Hereafter, a larger-delay device refers to one of the driving device and the brake device that has the response delay time larger than the other. A smaller-delay device refers to one of the driving device and the brake device that has the response delay time smaller than the other. The remaining parking distance reaching the correction threshold for the larger-delay device is the below-described satisfaction of the condition for the larger-delay device. The remaining parking distance reaching the correction threshold for the smaller-delay device is the below-described satisfaction of the condition for the smaller-delay device.

In step S103, if the condition for the larger-delay device is satisfied YES in S103), the process proceeds to step S104. If the condition for the larger-delay device is not satisfied (NO in S103), the process returns to S101 and repeats. The determination of whether or not the condition for the larger-delay device is satisfied may be made by the braking/driving force control unit 146.

In step S104, if the condition for the smaller-delay device is satisfied (YES in S104), the process proceeds to step S106. If the condition for the smaller-delay device is not satisfied (NO in S104), the process proceeds to S105. The determination of whether or not the condition for the smaller-delay device is satisfied may be made by the braking/driving force control unit 146. In step S105, the request value of the braking/driving force is generated only for the larger-delay device among the driving device and the brake device. Specifically, in the timing earlier than the reference output schedule by the response delay time of the larger-delay device, generation of the request value for the larger-delay device following the reference output schedule is started.

In step S106, if the condition for the reference is satisfied (YES in S106), the process proceeds to step S108. If the condition for the reference is not satisfied (NO in S106), the proceeds to S107. The determination of whether or not the condition for the reference is satisfied may be made by the braking/driving force control unit 146. In step S107, the request value of the braking/driving force is generated also for the smaller-delay device (i.e., not only for the larger-delay device but also for the smaller-delay device). Specifically, in the timing earlier than the reference output schedule by the response delay time of the smaller-delay device, generation of the request value for the smaller-delay device following the reference output schedule is started. In S107, the request value for the larger-delay device, generation of which has been already started, is also generated. In this step, the request value for the smaller-delay device and the request value for the larger-delay device are generated by shifting the timing (phase) in the reference output schedule by the response delay time of the larger-delay device and by the response delay time of the smaller-delay device, respectively.

In step S108, the request value of the braking/driving force for decelerating the vehicle toward the target vehicle-stop position is generated. In S108, the request value of the driving force and the request value of the braking force following the reference output schedule are generated. In S108, the marge process is executed to generate the request values of the larger-delay device and the smaller-delay device. The marge process, as described above, takes into the request values for the larger-delay device and the smaller-delay device adjusted in the timing earlier than the reference output schedule, generation of which request values has been already started.

In step S109, the request for output of the request value generated in S105, S107, or S108 is issued to the braking driving device. In step S110, if the host vehicle has reached the target parking position (YES in S110), the flow ends. If the host vehicle has not reached the target parking position (NO in S110), the process returns to S101 and repeats.

### Change in the Braking/Driving Force for Vehicle Stop in Control by the Braking Driving Control Unit 104

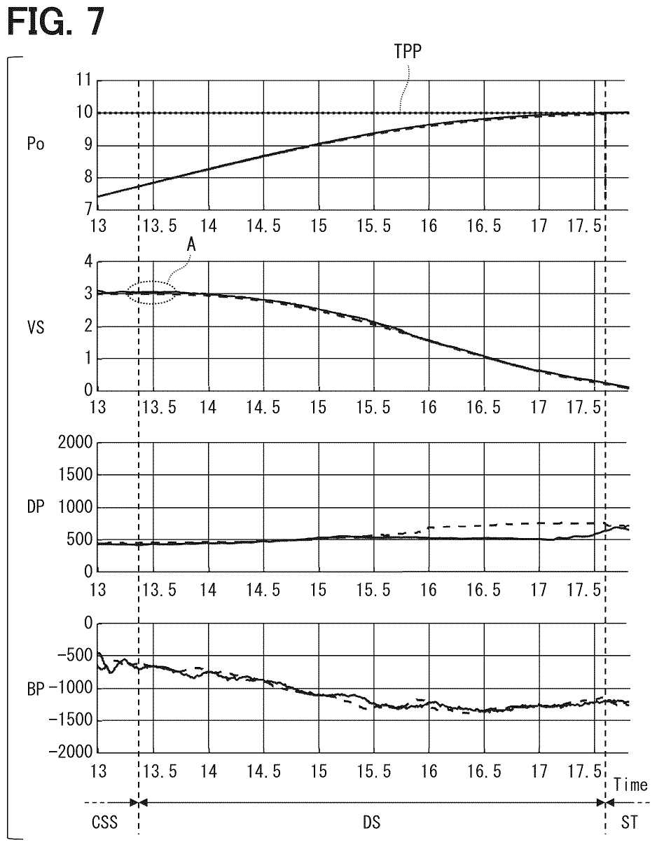

Using FIG. 7, a change in the braking/driving force for the vehicle stop at the target parking position in the control by the braking driving control unit 104 will be described. FIG. 7 illustrates an example case where the driving device is the smaller-delay device and the brake device is the larger-delay device. The horizontal axis of the graph in FIG. 7 is time. Po in FIG. 7 shows the change in the host vehicle position over time. TPP in FIG. 7 shows the target parking position. VS in FIG. 7 shows the change in the speed of the host vehicle over time. DP in FIG. 7 shows the change in the driving force of the host vehicle over time. BP in FIG. 7 shows the change in the braking force of the host vehicle over time. In FIG. 7, the solid lines show the actual values, and the dashed lines show the request values. CSS in FIG. 7 shows a duration of constant speed traveling. DS in FIG. 7 shows a duration of deceleration. Now, the change in the braking/driving force for the duration of deceleration will be described. The deceleration is assumed to be executed following the deceleration plan. ST in FIG. 7 indicates a time period after the vehicle stops. A in FIG. 7 shows a time period around a time point of start of the deceleration.

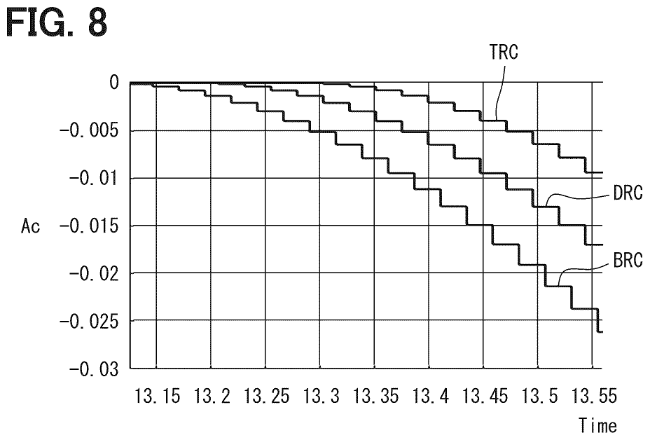

As shown in FIG. 7, the deceleration is achieved by increasing the braking force. Note that the larger the negative value of the braking force, the greater the braking force. In the deceleration, not only the braking force but also the driving force are requested. This is for adjusting the braking force by using the driving force. Now, using FIG. 8, generation of the requests in the time period A around the time point of start of the deceleration shown in FIG. 7 will be described. The horizontal axis of the graph in FIG. 8 shows time. In FIG. 8, Ac shows the change in the acceleration requested to the host vehicle over time. In FIG. 8, the acceleration is negative, which is also called deceleration. TRC in FIG. 8 is an ideal request value assuming no response delay time. DRC in FIG. 8 is the request value time-shifted in an early direction by the driving response delay time. BRC in FIG. 8 is the request value time-shifted in an early direction by the braking response delay time. As shown in FIG. 8, the requested value is generated in earlier timing by the response delay time. This enables the braking driving device to follow the request values with high accuracy. Therefore, it is possible to reduce the deviation between the request value and the actual value before the vehicle-stop and improve the accuracy of the vehicle-stop position.

### Second Embodiment

The first embodiment illustrates that the driver assist ECU 10 recognizes the traveling environment of the host vehicle by way example. The present disclosure is not limited to this. For example, a system may be configured such that an ECU other than the driver assist ECU 10 recognizes the traveling environment of the host vehicle. In this case, the driver assist ECU 10 may be configured to acquire information on the traveling environment recognized by the ECU other than the driver assist ECU 10.

### Third Embodiment

The first Embodiment illustrates the control of the braking/driving force for stopping the vehicle at the target parking position under the autonomous parking, but the present disclosure is not limited to this. For example, without limiting the autonomous traveling control to the autonomous parking, the control of the braking/driving force for stopping the vehicle at the target vehicle-stop position under the autonomous traveling control may be executed in a similar way. In this case, the target vehicle-stop position may be a position scheduled in the traveling plan of the autonomous traveling as a host vehicle stop position.

### Disclosure of Technical Ideas

The below listed technical ideas are part of the present disclosure.

### Technical Idea 1

A vehicular control device that is usable for a vehicle that executes autonomous traveling control includes:
a braking/driving force control unit that controls a driving force generated from a driving device of the vehicle and a braking force generated from a brake device of the vehicle;
a performance information acquisition unit that acquires performance information on performance of the vehicle, including a driving response delay time and a braking response delay time, wherein the driving response delay time is a response delay time of the driving device in responding to a force request and the braking response delay time is a response delay time of the brake device in responding to a force request; and
a reference output schedule determination unit that, without using the driving response delay time nor the braking response delay time, determines, as a reference output schedule, an output schedule of a driving force request and a braking force request for deceleration following a deceleration plan of the autonomous traveling control to stop the vehicle at a target vehicle-stop position, wherein the driving force request is a request to the driving force for the driving force and the braking force request is a request to the brake device for the braking force,
wherein the braking/driving force control unit provides the driving device with the request for the driving force following the reference output schedule in timing earlier than the reference output schedule by an amount corresponding to the driving response delay time acquired by the performance information acquisition unit and provides the brake device with the request for the braking force following the reference output schedule in timing earlier than the reference output schedule by an amount corresponding to the braking response delay time acquired by the performance information acquisition unit.

### Technical Idea 2

In the vehicular control device according to technical Idea 1:
from start of the deceleration in the deceleration plan, the braking/driving force control unit provides the driving device with the request for the driving force following the reference output schedule in the timing earlier than the reference output schedule by the amount corresponding to the driving response delay time and provides the brake device with the request for the braking force following the reference output schedule in the timing earlier than the reference output schedule by the amount corresponding to the braking response delay time.

### Technical Idea 3

The vehicular control device according to technical Idea 2 further includes:
a reference threshold determination unit that, without using the driving response delay time nor the braking response delay time, determines a reference threshold depending on speed of the vehicle and a remaining distance from the vehicle to the target vehicle-stop position, wherein the reference threshold is a value of the remaining distance for the vehicle to start the deceleration; and
a correction threshold determination unit that determines: a driving-side threshold by correcting the reference threshold for the driving device such that the driving-side threshold is larger than the reference threshold by an amount corresponding to the driving response delay time acquired by the performance information acquisition unit; and a braking-side threshold by correcting the reference threshold for the brake device such that the braking-side threshold is larger than the reference threshold by an amount corresponding to the braking response delay time acquired by the performance information acquisition unit, wherein:
when the remaining distance reaches the driving-side threshold determined by the correction threshold determination unit, the braking/driving force control unit starts providing the request for the driving force scheduled in the reference output schedule as the driving force at a time to start the deceleration; and
when the remaining distance reaches the braking-side threshold determined by the correction threshold determination unit, the braking/driving force control unit starts providing the request for the braking force scheduled in the reference output schedule as the braking force at a time to start the deceleration.

### Technical Idea 4

In the vehicular control device according to any one of technical Ideas 1 to 3:
the vehicular control device is usable for the vehicle that executes the autonomous traveling control for autonomous parking; and
when the deceleration is executed to stop the vehicle at the target vehicle-stop position under the autonomous parking, the braking/driving force control unit provides the driving device with the request for the driving force following the reference output schedule in the timing earlier than the reference output schedule by the amount corresponding to the driving response delay time acquired by the performance information acquisition unit and provides the brake device with the request for the braking force following the reference output schedule in the timing earlier than the reference output schedule by the amount corresponding to the braking response delay time acquired by the performance information acquisition unit.

The present disclosure is not limited to the embodiments described above and can be modified in various ways within the spirit and scope of the present disclosure. An embodiment obtained by appropriately combining technical features disclosed in different embodiments may also be included in the present disclosure. The control units and methods thereof described in the present disclosure may be implemented by a special purpose computer provided by configuring a processor programmed to execute one or more functions embodied by a computer program. Alternatively, the control units and methods thereof described in the present disclosure may be implemented by a dedicated hardware logic circuit. Alternatively, the control units and methods thereof described in the present disclosure may be implemented by one or more special purpose computer provided by configuring a processor executing a computer program in combination with one or more hardware logic circuits. The computer program may be stored on a computer-readable non-transitory tangible storage medium as instructions executed by a computer.

What is claimed is:

1. A vehicular control device that is usable for a vehicle that executes autonomous traveling control, comprising:
at least one processor that executes a program and/or at least one dedicated circuit, configured to:
in a braking/driving force control process, control a driving force generated from a driving device of the vehicle and a braking force generated from a brake device of the vehicle;
in a performance information acquisition process, acquire performance information on performance of the vehicle, including a driving response delay time and a braking response delay time, wherein the driving response delay time is a response delay time of the driving device in responding to a force request and the braking response delay time is a response delay time of the brake device in responding to a force request; and
in a reference output schedule determination process, without using the driving response delay time nor the braking response delay time, determine, as a reference output schedule, an output schedule of a driving force request and a braking force request for deceleration following a deceleration plan of the autonomous traveling control to stop the vehicle at a target vehicle-stop position, wherein the driving force request is a request to the driving force for the driving force and the braking force request is a request to the brake device for the braking force,
wherein the at least one processor and/or the at least one dedicated circuit is configured to, in the braking/driving force control process,
provide the driving device with the request for the driving force following the reference output schedule in timing earlier than the reference output schedule by an amount corresponding to the driving response delay time and
provide the brake device with the request for the braking force following the reference output schedule in timing earlier than the reference output schedule by an amount corresponding to the braking response delay time.

2. The vehicular control device according to claim 1,
wherein the at least one processor and/or the at least one dedicated circuit is configured to, in the braking/driving force control process,
from start of the deceleration in the deceleration plan, provide the driving device with the request for the driving force following the reference output schedule in the timing earlier than the reference output schedule by the amount corresponding to the driving response delay time and provide the brake device with the request for the braking force following the reference output schedule in the timing earlier than the reference output schedule by the amount corresponding to the braking response delay time.

3. The vehicular control device according to claim 2,
wherein the at least one processor and/or the at least one dedicated circuit is configured to:
in a reference threshold determination process, without using the driving response delay time nor the braking response delay time, determine a reference threshold depending on speed of the vehicle and a remaining distance from the vehicle to the target vehicle-stop position, wherein the reference threshold is a value of the remaining distance for the vehicle to start the deceleration;
in a correction threshold determination process, determine a driving-side threshold by correcting the reference threshold for the driving device such that the driving-side threshold is larger than the reference threshold by an amount corresponding to the driving response delay time and determine a braking-side threshold by correcting the reference threshold for the brake device such that the braking-side threshold is larger than the reference threshold by an amount corresponding to the braking response delay time;
in the braking/driving force control process, when the remaining distance reaches the determined driving-side threshold, start providing the request for the driving force scheduled in the reference output schedule as the driving force at a time to start the deceleration; and
in the braking/driving force control process, when the remaining distance reaches the determined braking-side threshold, start providing the request for the braking force scheduled in the reference output schedule as the braking force at a time to start the deceleration.

4. The vehicular control device according to claim 1, wherein:
the vehicular control device is usable for the vehicle that executes the autonomous traveling control for autonomous parking; and
the at least one processor and/or the at least one dedicated circuit is configured to:
in the braking/driving force control process, when the deceleration is executed to stop the vehicle at the target vehicle-stop position under the autonomous parking, provide the driving device with the request for the driving force following the reference output schedule in the timing earlier than the reference output schedule by the amount corresponding to the driving response delay time and provide the brake device with the request for the braking force following the reference output schedule in the timing earlier than the reference output schedule by the amount corresponding to the braking response delay time.

5. A vehicular control method executed by at least one processor and usable for a vehicle that executes autonomous traveling control,
the vehicular control method comprising:
controlling a driving force generated from a driving device of the vehicle and a braking force generated from a brake device of the vehicle;
acquiring performance information on performance of the vehicle, including a driving response delay time and a braking response delay time, wherein the driving response delay time is a response delay time of the driving device in responding to a force request and the braking response delay time is a response delay time of the brake device in responding to a force request; and
without using the driving response delay time nor the braking response delay time, determining, as a reference output schedule, an output schedule of a driving force request and a braking force request for deceleration following a deceleration plan of the autonomous traveling control to stop the vehicle at a target vehicle-stop position, wherein the driving force request is a request to the driving force for the driving force and the braking force request is a request to the brake device for the braking force,
wherein controlling the driving force and the braking force includes:
providing the driving device with the request for the driving force following the reference output schedule in timing earlier than the reference output schedule by an amount corresponding to the driving response delay time; and
providing the brake device with the request for the braking force following the reference output schedule in timing earlier than the reference output schedule by an amount corresponding to the braking response delay time.
